(19) United States
(12) Patent Application Publication
(10) Pub. No.: US 2021/0019663 A1
(43) Pub. Date: Jan. 21, 2021

(54) FAULT TOLERANCE, CORRECTION, AND ATTACK DETECTION THROUGH MULTIPLE CONTINUOUS TRANSFORMATIONS OF INPUTS

(71) Applicant: NXP B.V., Eindhoven (NL)

(72) Inventors: Nikita VESHCHIKOV, Brussels (BE); Joppe Willem BOS, Wijgmaal (BE); Simon Johann FRIEDBERGER, Heverlee (BE); Brian ERMANS, 's-Hertogenbosch (NL)

(73) Assignee: NXP B.V.

(21) Appl. No.: 16/512,805

(22) Filed: Jul. 16, 2019

(51) Int. Cl. G06N 20/20; G06N 5/04; G06F 17/18

(52) U.S. Cl. CPC G06N 20/20; G06F 17/18; G06N 5/043

(57) ABSTRACT

A method for processing information includes transforming first information based on a first function, transforming second information based on a second function, processing the first transformed information using a first machine-learning model to generate a first result, processing the second transformed information using a second machine-learning model to generate a second result, and aggregating the first result and the second result to generate a decision. The first and second information may be the same information. The first function may be different from the second function. The first machine-learning model may be based on a first algorithm, and the second machine-learning algorithm may be based on a second algorithm.

### TECHNICAL FIELD

Example embodiments disclosed herein relate generally to processing information using machine-learning techniques.

### BACKGROUND

Many data processing problems may be solved using machine-learning algorithms. Machine-learning algorithms use a set of statistical tools to extract information from data that is not possible using human-implemented methods.

While machine-learning models have solved many problems, they are not without drawbacks. Machine-learning models are not always secure. For example, a malicious attacker who gains unauthorized access to a host system may be able to manipulate data in a way that misleads a machine-learning model into making a wrong decision. In this latter case, consider a machine-learning which is able to distinguish pictures of cats and dogs. A malicious attacker may change pixels in the image of a dog in such a way that the modification is not even visible to the human eye, but at the same time would be recognized as an image of a cat by the machine-learning system. Such intentionally crafted inputs may be referred to as adversarial examples.

Other malicious attacks may exploit the notion that machine-learning models will always provide an answer, even if the input query is non-sensical. In this case, existing models are not able to determine whether the input query is from the input domain the model was trained for. By querying the model with questions that do not belong to the problem-domain of the model, the behavior of the model on the problem-domain can be copied or otherwise adversely affected, without having access to the model itself.

### SUMMARY

A brief summary of various example embodiments is presented below. Some simplifications and omissions may be made in the following summary, which is intended to highlight and introduce some aspects of the various example embodiments, but not to limit the scope of the invention. Detailed descriptions of example embodiments adequate to allow those of ordinary skill in the art to make and use the inventive concepts will follow in later sections.

Example embodiments include a method for processing information including transforming first information based on a first function; transforming second information based on a second function; processing the first transformed information using a first machine-learning model to generate a first result; processing the second transformed information using a second machine-learning model to generate a second result; and aggregating the first result and the second result to generate a decision, wherein the first information is equal to the second information. In one embodiment, the second information may be a copy of the first information, or the first information and second information may be copies of a single input. In one embodiment, the second machine-learning model may be exactly the same as the first machine-learning model. Also, in one embodiment, multiple different transformations may be applied to the same model OR multiple models.

The first function may be different from the second function, the first machine-learning model may be based on a first algorithm, and the second machine-learning algorithm may be based on a second algorithm different from the first algorithm. The first function may change a first parameter of the first information, the second function may change a second parameter of the second information which is different from the first parameter.

The aggregating operation may include applying a voting algorithm to the first result and the second result to generate the decision. The aggregating may include applying a statistical algorithm to the first result and the second result to generate the decision. The decision may classify input information corresponding to the first information and the second information. The decision may be an undefined decision.

The method may include a) performing one or more additional transformations, b) processing information from the one or more additional transformations using a third machine-learning model to generate a third result, and c) aggregating the first result, the second result, and the third result to generate another decision different from the undefined decision, wherein the information processed in c) is equal to the first information and the second information. The third machine-learning model may correspond to the first machine-learning model with at least one parameter changed, the second machine-learning model with at least one parameter changed, or a machine-learning model different from the first machine-learning model and the second machine-learning model.

In accordance with one or more embodiments, a system for processing information includes a first module configured to transform first information based on a first function; a second module configured to transform second information based on a second function; a processing system configured to process the first transformed information using a first machine-learning model to generate a first result and to process the second transformed information using a second machine-learning model to generate a second result; and an aggregator configured to generate a decision based on the first result and the second result, wherein the first information is equal to the second information. The same processor or separate processors may be used to perform the aforementioned operations of the processing system.

The first function may be different from the second function, the first machine-learning model may be based on a first algorithm, and the second machine-learning algorithm may be based on a second algorithm different from the first algorithm. The first function may change a first parameter of the first information, the second function may change a second parameter of the second information which is different from the first parameter. The aggregator may be configured to generate the decision using a voting algorithm or a statistical algorithm. The decision may classify input information corresponding to the first information and the second information. The decision may be an undefined decision. The first and second processors may be the same processor.

In accordance with one or more other embodiments, a non-transitory computer-readable medium stores instructions for causing at least one processor to perform operations including transforming first information based on a first function, transforming second information based on a second function, processing the first transformed information using a first machine-learning model to generate a first result, processing the second transformed information using a second machine-learning model to generate a second result, and aggregating the first result and the second result to generate a decision, the first information equal to the second information. The first function may be different from the second function, the first machine-learning model may be based on a first algorithm, and the second machine-learning algorithm may be based on a second algorithm different from the first algorithm. The first function may change a first parameter of the first information, the second function may change a second parameter of the second information which is different from the first parameter.

### BRIEF DESCRIPTION OF THE DRAWINGS

Additional objects and features of the invention will be apparent from the following detailed description when taken in conjunction with the drawings. Although several example embodiments are illustrated and described, like reference numerals identify like parts in each of the figures, in which:

FIG. 1 illustrates a system for processing information using a machine-learning model;

FIG. 2 illustrates an embodiment of a system for processing information using a plurality of machine-learning models;

FIG. 3 illustrates an embodiment of a selector for selecting transformation functions;

FIG. 4 illustrates another embodiment of a system for processing information using a plurality of machine-learning models;

FIG. 5 illustrates an embodiment of a method for processing information using a plurality of machine-learning models; and

FIG. 6 illustrates an embodiment of a processing system.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

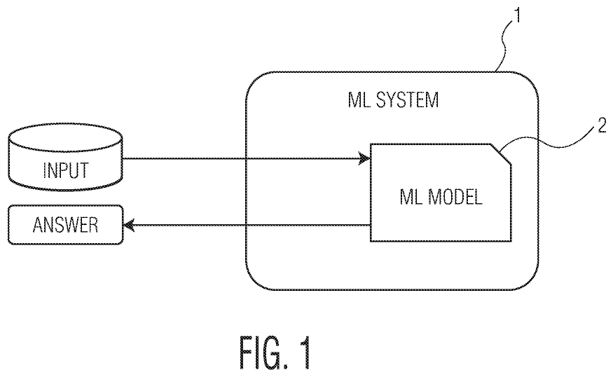

FIG. 1 illustrates an example of one type of system 1 which processes information using a machine-learning model 2. In this system, the machine-learning model generates an answer based on input information. Because only a single machine-learning model is used to process the input information to generate the answer, system 1 is vulnerable to malicious attack. For example, by using only one machine-learning model to process input information, the system is prime target for various types of malicious attacks, including but not limited to adversarial examples, non-sensical inputs, and queries outside the training domain of the model.

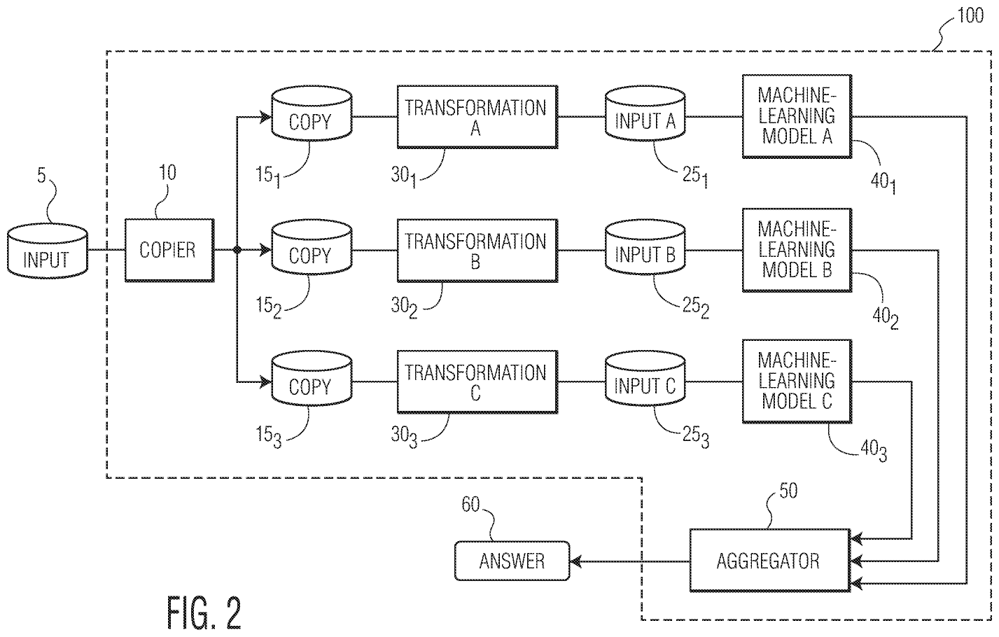

FIG. 2 illustrates an embodiment of a system 100 for processing information using a plurality of machine-learning algorithms. The system includes a copier 10, a plurality of buffers (or other storage locations) 15₁, 15₂, and 15₃, a plurality of transformation modules 30₁, 30₂, and 30₃, a plurality of machine-learning models 40₁, 40₂, and 40₃, and an aggregator 50 for outputting a processing result (or answer) based on the input information (or input query). In the system of FIG. 2, three copies, transformations, and models are used to generate the output. A different number of copies, transformations, and/or models may be used in another embodiment.

The copier 10 generates a predetermined number of copies 15₁, 15₂, and 15₃ of input information 5. In one embodiment, the input information may be expressed as a query to a question that lies within the scope of a domain for which the models have been (or are being) trained. In another embodiment, the input information may include data, key words, and/or other types of inputs for which the machine-learning models have been trained. The number of copies of the input information generated by the copier 10 may be based, for example, on predetermined requirements of an intended application of the system 100 and/or restrictions imposed by various resources of system 100 and/or those of a host system that includes or is otherwise being used by system 100. For example, the restrictions may include restrictions on or imposed by computational resources, which may include, for example, time restrictions, memory space restrictions, energy, numbers of central processing units (CPUs), etc. In one embodiment, the number of copies may be one fewer than the number of machine-learning models, with the remaining one corresponding to the original input 5.

The transformation modules 30₁, 30₂, and 30₃ applies a different transformation function to the copy of the input information generated by the copier. For example, the first copy of the input information may be transformed based on a function A applied by module 30₁, the second copy of the input information may be transformed based on a function B applied by module 30₂, and the third copy of the input information may be transformed based on a function C applied by module 30₃. In one embodiment, transformation functions A, B, and C may be predetermined for respective ones of the modules.

In another embodiment, system 100 may be programmed to apply a set of transformation functions (e.g., equal to or greater than the number of machine-learning models). A selector may select (e.g., using a predetermined algorithm) the transformation functions to be applied by the modules of system 100. The predetermined algorithm may be one that randomly selects, from the set, the transformation functions for the modules to apply or one that uses a different type of algorithm to make the selection, for example, based on the type of machine-learning model. For example, each of the transformation functions A, B, and C may be selected to match the particular requirements or type of processing to be implemented by the machine-learning model situated along its processing path. In one embodiment, the transformation functions may be variants of a same function (e.g., may differ in respect to one or more parameters, coefficients, and/or variables). Because the functions applied by transformation modules 30₁, 30₂, and 30₃ are different, their outputs will also be different. These outputs correspond to inputs A, B, and C of the machine-learning models A, B, and C, respectively.

The machine-learning models 40₁, 40₂, and 40₃ generate outputs based on the different inputs A, B, and C, produced by corresponding ones of the transformation functions. The machine-learning models 40₁, 40₂, and 40₃ generate their outputs using different algorithms, which, for example, may be predetermined, programmed, and trained for the intended application of the system 100. In one embodiment, the machine-learning models 40₁, 40₂, and 40₃ may be variants of a same algorithm (e.g., may differ in respect to one or more parameters) or may be algorithms. In one embodiment, the machine-learning models 40₁, 40₂, and 40₃ may be different inference algorithms. In another embodiment, the machine-learning models may be identical. Examples of machine-learning models that may be used in accordance with one or more embodiments are described in greater detail below.

The aggregator 50 combines the outputs of machine-learning models 40₁, 40₂, and 40₃ to generate an output 60, e.g., the aggregator may generate a single answer for the single input 5 to the system 100. The input (or answer) may then be output to a user, for example, on a display and/or input into another part of the system for continued processing. Example embodiments of system 100 are discussed in greater detail below.

### Transformation Functions

The transformation functions A, B, and C applied by modules 30₁, 30₂, and 30₃ may be different from one another, as discussed. In one embodiment, system 100 may be programmed with a set of K transformation functions for transforming copies of the input information output from copier 10, where K equal to N or different from (less than or greater than N corresponding to the number of machine-learning models used by the system. While different, the transformation functions should not modify the copied input information in such a way that the transformed result becomes useless for purposes of generating a desired output, e.g., which lies outside the scope of the training of corresponding ones of the machine-learning models or which otherwise may generated an inaccurate or erroneous result.

In at least one embodiment, the transformation functions are domain-specific, e.g., lie within the domain used to train corresponding ones of the machine-learning models. For example, if system 100 is used to process images, the transformation functions C applied by modules 30₁, 30₂, and 30₃ may perform different ones of rotations, stretching, color modifications (hue, saturation, light), flipping along an axis, or cropping of a copied input image. These transformation functions do not change the object represented in (or essential content of) the copied input image, but they do transform the copied input image in different ways. For example, if the original input information 5 is an image of a dog, then the transformed output of each of transformation modules would still be an image which depicts the dog but rotated, stretched, etc. If the transformation function changed the input to such an extent that a dog is no longer depicted, such a transformation function may be considered to lie outside of the permissible domain of the machine-learning algorithms and/or the intended application of the system 100. Another example of an impermissible transformation function may be one which desaturates the input image. This example would apply when the presence of color is considered to be crucial for the intended application of the system.

Another example of input information is an audio recording of speech. In this case, the transformation modules 30₁, 30₂, and 30₃ may modify the input recording, for example, by changing the speed or pitch of the entire recording or different parts thereof. These modifications would not change the essential features (e.g., content) of the recording (e.g., the spoken words would remain the same), but would affect other differences that may be considered to be non-essential.

In one embodiment, one or more of the transformation functions may change more than one parameter at a time. For example, in case of image classification problems, one of the transformation functions may rotate the image in a first direction and another one of the transformation functions may both rotate the image in a second direction and perform a color transformation. Also, the image may be rotated by a different angle regardless of direction.

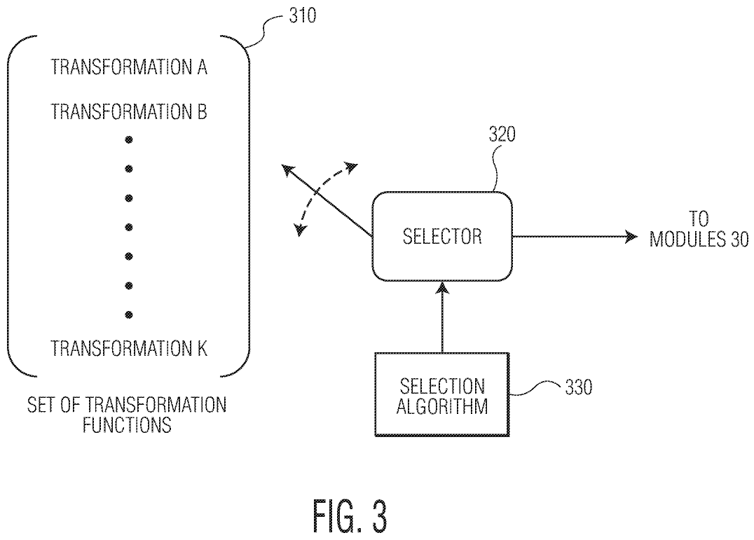

FIG. 3 illustrates an example of how the transformation functions of modules 30₁, 30₂, and 30₃ may be selected in system 100. Referring to FIG. 3, the system 100 may include a first memory 310, selector 320, and a second memory 330. The first memory 310 may be programmed with or otherwise designating a number K of transformation functions, where K may be equal to or different from the number of machine-learning models 40₁, 40₂, and 40₃. The selector 320 may select the transformation functions that are to be used in modules 30₁, 30₂, and 30₃ for transforming different copies 15₁, 15₂, and 15₃ of the input information 5. The selector 320 may make these selections, for example, based on instructions stored in the second memory 330 and/or in accordance with input information from a user designating the functions. The instructions may instruct the selector to make the selections, for example, randomly or based on a predetermined algorithm, as described herein.

The predetermined algorithm for controlling selector 320 may implemented one or more of the following strategies for selecting the transformation functions from the set.

Fixed and Deterministic. A fixed and deterministic algorithm may be used to select the transformation function(s) for one or more of the modules 30₁, 30₂, and 30₃. In this case, for every input 5 into the system 100, the same set of different transformation functions may be respectively applied to the modules. That is, each transformation function may use the same fixed parameter(s), at least one of which is different among the transformation functions. For example, every time 3 copies of the original input are made, the copies may always be transformed using transformation functions A₁, B₁, and C₁. Transformation function A₁ may always use fixed parameters aᵢ and aᵢ. Transformation function B₁ may always use fixed parameter bᵢ. Transformation function C₁ may always use fixed parameters cᵢ, c₁, and cₖ. In some cases, the transformation functions may have at least one parameter in common. In another embodiment, some of the functions may not require a parameter and some may, e.g., function A₁ may flip the image (no parameter) and function B₁ may change the color of the image (color parameter).

Fully Random. A fully random algorithm may be used to select the transformation function(s) for one or more of the modules 30₁, 30₂, and 30₃. In this case, every time a new input 5 is received, the selector 320 randomly selects the transformation functions for the modules 30₁, 30₂, and 30₃. Additionally, or alternatively, if the transformation function has at least one parameter, the parameter may be randomly selected by the selector 320, for example, within a range of acceptable values as determined by the programming instructions stored in the second memory 330.

Rotational Algorithm. A rotational algorithm may be used to select the transformation functions for the modules 30₁, 30₂, and 30₃. In this algorithm, the same transformational functions are rotated through respective ones of the modules 30₁, 30₂, and 30₃ by a predetermined increment each time input information 5 is received. For example, in a first iteration module 30₁ applies transformation function A, module 30₂ applies transformation function B, and module 30₃ applies transformation function C. In the next iteration, a sequential rotation is performed by selector 320, where module 30₁ applies transformation function C, module 30₂ applies transformation function A, and module 30₃ applies transformation function B. In the sequential rotation is performed using an increment of 1 each time an input is received.

Combination Algorithm. Two or more of the aforementioned algorithms may be combined to select the transformation functions for the modules 30₁, 30₂, and 30₃. For example, the transformation functions for the modules may be selected in a fixed and deterministic manner, while parameters of the transformation functions may be selected at random, and vice versa. Also, in one embodiment, the same set of functions and their parameters may be used to handle multiple user inputs. This set may be refreshed at predetermined times, e.g., every several minutes or after several requests from users. In other embodiments, an algorithm for selecting the transformation functions may be different from the ones discussed above.

In at least one embodiment, the order in which transformation functions are applied may not be important with respect to the output of the entire system. Also, in some embodiments the numbers K (number of transformation functions in the set) and N (number of machine-learning algorithms) may have an effect on the robustness of the system. Depending on the intended level of robustness, additional transformation functions may be applied on the copied input or the original input.

In one embodiment, one or more of the modules 30₁, 30₂, and 30₃ may apply a complex transformation function. An example of a complex transformation function involves applying multiple single transformation functions (e.g., as discussed above) one after the other (in a chain) on the copied input(s). For example, when system 100 is used for image processing, one of the modules may perform the following transformation functions in tandem on a copied input image: rotate, then crop, then change contrast. The resulting transformation may then be input into a corresponding one of the machine-learning models.

### Machine-Learning Models

The machine-learning models 40₁, 40₂, and 40₃. may be applied to the transformed information output from respective ones of the modules 30₁, 30₂, and 30₃. As discussed, the machine-learning models 40₁, 40₂, and 40₃ may be different from one another, in that, for example, the models may apply different machine-learning algorithms to their respective transformed inputs. The machine-learning models may be applied in a variety of ways. Examples are discussed below.

Fully Parallel Approach. The processing performed by the machine-learning models may be applied in parallel (e.g., simultaneously), provided sufficient processing resources exist in the system and/or under conditions where time constraints are high. . The results output from the models may then be stored in one or more memories, which may then subsequently output the results to the aggregator 50. The processing resource implementing each model may be the same or different. For example, the processing resources for implementing the models may include a central processing unit (CPU), a graphics processing unit (GPU), a digital signal processor, a specially dedicated hardware module, or a combination thereof. In one embodiment, the processing resource(s) used to implement the models may be referred to as an inference engine.

Fully Sequential. The processing performed by the machine-learning models may be applied in a fully sequential manner. For example, one processing resource (e.g., processor) may sequentially perform the processing operations of the models for respective ones of the transformed inputs. For example, a single processor may process transformed input (A) 25₁ using the algorithm for machine-learning model (A) 40₁. Then, the same processor may process transformed input (B) 25₂ using the algorithm for machine-learning model (B) 40₂. Then, the same processor may process transformed input (C) 25₂ using the algorithm for machine-learning model (C) 40₃. Such an approach may be taken, for example, when hardware constraints are high and more processing time is available. The processor may store the results output from the models in one or more memories, which may then subsequently output the results to the aggregator 50.

Batch-Based. The processing performed by the machine-learning models may be applied in a batch-based manner. In this case, multiple processors may be used, at the same time or different times, to process different portions of each of the transformed inputs A, B, and C.

Examples of machine-learning models that may be used in system 100 include support vector machines and random forest (decision trees), as well as others. The models may be determined, for example, based on the time, resource, and/or other constraints or features of the system 100. The results of the models may take various forms. For example, a model that distinguishes cats and dogs (image classification) may produce an output as follows: Image contains a dog: probability 0.63; Image contains a cat: probability 0.37. Based on these results, the model output may be dog.

In one embodiment, different machine-learning models may be used to perform an inference along each processing path, instead of using always using the same model. For example, each transformed input A, B, and C may be processed by multiple models and different outputs may be collected as in the original case (with one model applied on all modified copies).

### Aggregation

The aggregator 50 generates an output 60 based on the results from the machine-learning models (which processed different transformed copies of the input information). Various aggregation algorithms may be used to generate output 60, examples of which are discussed below.

Voting Algorithm. The aggregator 50 may use a voting algorithm to generate output 60 based on the outputs of the models. Such an algorithm may be used, for example, for classification problems, e.g., when assigning a category such as “cat” or “dog” to an input image. An example of a voting algorithm is majority voting algorithm applied to the model outputs.

Statistical Algorithm. The aggregator 50 may use a statistical algorithm to generate output 60 based on the output of the models. Such an algorithm may be used, for example, for regression problems, e.g., predicting a price of goods in the market. Examples of statistical algorithms include ones that generate an average or median value based on the model outputs. A different aggregation algorithm may be used by aggregator 50 in another embodiment.

In one embodiment, the aggregator 50 may output a result (answer) 60 that is consistent with at least one of the results generated by the machine-learning models. In another case, the aggregator may generate a special “undefined” output meaning that no answer was able to be obtained. This latter case may arise, for example, when a sufficient level of confidence cannot be placed in the answers generated by the machine-learning models, e.g., when all of the machine-learning models produce different results.

Generating the “undefined” output may help system 100 to make less errors, for example, by outputting an answer of “none of the above” or “I do not know” given present data and information. For example, consider the case where an original image is input into system 100, which performs image classification using an even number of machine-learning models trained to recognize cats and dogs. When half of the machine-learning models indicate cat and the other half of the models indicate dog, the result is indeterminate. In this case, the aggregator 50 may output an “undefined” answer indicating that the classification cannot be determined with a sufficient degree of confidence.

Such an embodiment may filter out images that are not in the problem domain of the system 100, e.g., in the example given, the system is only able to classify an input image as a dog or cat. When an image is input that does not include a dog or cat (e.g., a kangaroo), the system 100 may output an “undefined” answer, instead of attempting to guess whether the image includes a dog or cat, either one of which would be an erroneous answer. The embodiments described herein may therefore reduce the number of errors output by the system. The embodiments may also prevent or lessen the effectiveness of malicious attacks performed using model cloning techniques or based on the input of images that lie outside of the domain of the machine-learning models.

Moreover, in one embodiment the aggregator 50 may maintain a log of previous results. The results may be analyzed (e.g., statistically by a processor) to determine whether or not one or more of the machine-learning models is being used for its intended purpose. For example, if one or more machine-learning models produced results which are inconsistent with results produced by the other models more than a predetermined number of times, then the one or more machine-learning models may be replaced with more effective ones, e.g., ones more relevant to the types of information to be input into the system or another modification may be made. The log of previous results may be organized based on the user and/or in various ways.

In one embodiment, aggregator 50 may generate confidence levels with the decisions output from the machine-learning models. The confidence levels may be expressed, for example, as probabilities. For example, consider the case where three machine-learning models M1, M2, and M3 are used. The model M1 may indicate a probability of 0.8 for cat and a probability of 0.2 for dog. The model M2 may indicate a probability of 0.6 for cat and 0.4 for dog. The model M2 may indicate a probability of 0.7 for cat and 0.3 for dog. The final result may be generated based on a vote scheme. In this present example, all three models produced a greater probability that the result is cat. Thus, the voting results would be 3 for cat and 0 for dog. Based on the voting results, the output would be cat. The confidence level that the correct result is cat may be computed, for example, as follows: (0.8+0.6+0.7)/3=0.7, which is an average of the confidence levels of the three models.

Consider, for example, the case where system 100 uses four transformation modules A, B, C, and D coupled to a respective number of machine-learning models, which output decisions as to whether an input image includes a cat or dog. In such an example, the machine-learning models (MLs) may produce the following results with corresponding confidence levels expressed as a percentage:

| Transformation | ML Decisions with |
|---|---|
| Function | Confidence Levels |
| A | dog (80%), cat (20%) |
| B | dog (40%), cat (60%) |
| C | dog (45%), cat (55%) |
| D | dog (90%), cat (10%) |

In this example, the aggregator 50 may determine that the final answer is “dog,” even though two times the transformed copies were classified as “dog” and two times as “cat.” This final answer may be returned based on the highest percentages, e.g., machine-learning models A and D returned the classification of “dog” with 80% and 90% confidence levels, whereas the highest confidence levels associated with the classification of “cat” was far lower at 55% and 60%.

### Dynamic Stepwise Aggregation

In one embodiment, the aggregator 50 may output a decision using a dynamic stepwise aggregation method. Such a method may involve generating a dynamic number of transformed copies for input into the machine-learning models. Instead of always creating N copies of the original input and transforming the copies using modules 30, one or more of the machine-learning models 40 may process a small number of transformed copies and then create extra (different) transformed copies until some agreement is reached during aggregation. This may be illustrated as follows.

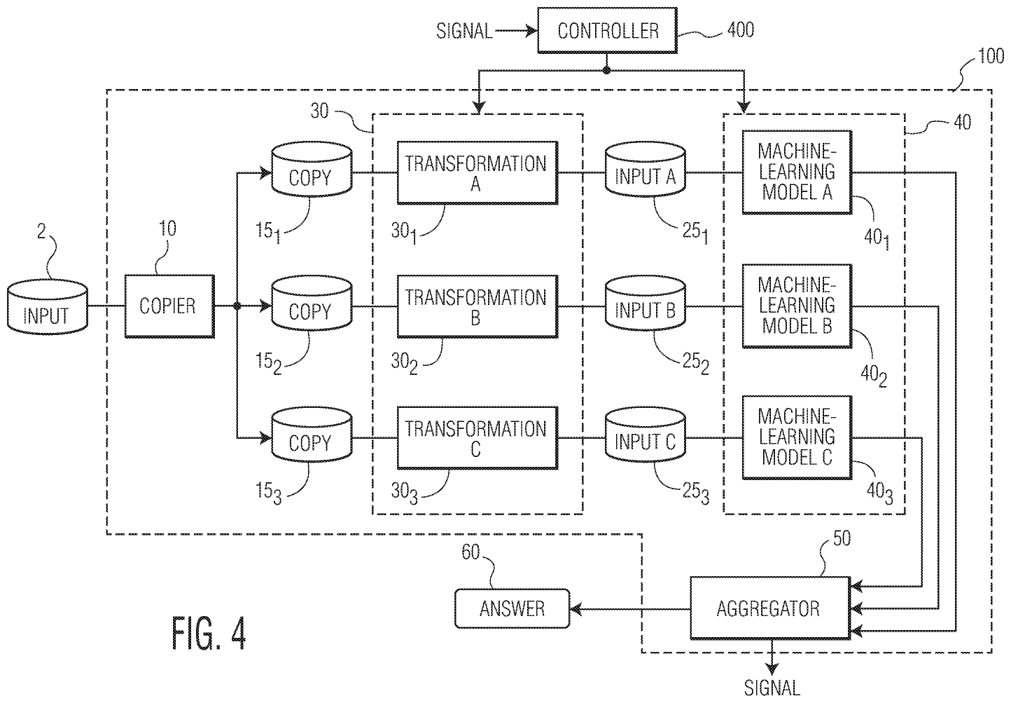

Consider the case where system 100 initially generates two copies of input information which are processed using different transformation functions. The transformed copies are then input into respective machine-learning models. If the classifications output from the machine-learning models agree, the aggregator 50 may output the classification as answer 60. If the classifications output from the machine-learning models do not agree, then the aggregator may generate a signal for input into a controller 400 of the system 100, as illustrated, for example, in FIG. 4.

The controller 400 may control one or more of the modules 30 to create new (different) transformations of the original input information. The modules may be the same one(s) initially used (loaded with new transformation function(s)) or may be an additional one or more of the modules 30 in the system not initially used. The transformed information is then input into a corresponding number of machine-learning models (which may be the same or different the ones initially used) to generate one or more other classifications. The aggregator 50 may then generate an output 60 based on all of the classifications. For example, if the two models initially used indicate 1 dog and 1 cat and the additional processing yielded 1 dog, then the total results would be 2 dogs and 1 cat. Using a majority voting algorithm, the aggregator 50 may generate the final answer 60 indicating dog.

Other numbers of transformations and models may be used, or additional processing may be performed, to achieve a higher degree of agreement in other embodiments. The controller 400 may stop the process, for example, after a predetermined number of (e.g., 20) transformations and model outputs are generated without clear agreement, e.g., if the same number of different classifications are obtained. In this case, the aggregator 50 may generate an “undefined” final output. A similar approach may be used for regression machine-learning problems e.g., an output may be produced from the system if the variance is lower than a predefined threshold or a new transformation and model output may be generated the variance is equal to or greater than the predefined threshold.

### Experimental Results on Detection of Non-Problem Domain Data

An experiment was performed to simulate system 100 for classifying images. The experiment involved training a machine-learning model (Convolution Neural Network) using a predetermined (standard, non-transformed CIFAR-10) dataset. The trained model was then queried using problem domain (PD) images (the test set of CIFAR-10) and non-problem domain (NPD) images (random images from ImageNet) as inputs. Both groups contained 10,000 samples. The number of times the transformed samples produced different answers (e.g., disagreements) from the original, non-transformed sample was then counted and statistics were gathered, as indicated in Table 1.

TABLE 1

| Transformation | Disagreement on | Disagreement on | Ratio |
|---|---|---|---|
| Function | PD (per 10,000) | NPD (per 10,000) | (NPD/PD) |
| Vertical flip | 6407 | 6724 | 1.05 |
| Horizontal flip | 1753 | 4645 | 2.65 |
| Rotate 90° | 7012 | 7368 | 1.05 |
| Rotate 180° | 6473 | 6820 | 1.05 |
| Rotate 270° | 6936 | 7342 | 1.06 |

As shown in Table 1, the number of disagreements on the NPD samples was significantly higher than the number of disagreements for the PD samples for the horizontal flip transformation function. Due to the nature of image classification test sets, horizontal flips on the PD were in general well handled. The image classification model learned to ignore whether a dog was facing left or right in the input image, while uncertainty associated with NPD images showed when the samples were transformed. By monitoring the history of disagreements, a sudden increase in disagreement rate (e.g., by controller 400) may provide a basis for detecting that a strong indicator for the model being under cloning attack.

This experiment shows that the embodiments described here are beneficial for purposes of increasing accuracy of the final result, protecting against malicious attack, and reducing processing overhead and costs. In this particular experiment, the original model did not need to be adapted during the training phase. Users may therefore use the system and methods of the present embodiments on existing models, without having to change them.

If a better detection rate is desired, the transformations may be incorporated during the training phase in a modified embodiment. Table 2 shows an example of the disagreement rate obtained during the experiment when the model was trained while randomly flipping the samples horizontally.

TABLE 2

| Transformation | Disagreement on | Disagreement on | Ratio |
|---|---|---|---|
| Function | PD (per 10,000) | NPD (per 10,000) | (NPD/PD) |
| Vertical flip | 6093 | 6372 | 1.05 |
| Horizontal flip | 1048 | 3438 | 3.28 |
| Rotate 90 deg | 6415 | 6827 | 1.06 |
| Rotate 180 deg | 6102 | 6401 | 1.05 |
| Rotate 270 deg | 6475 | 6806 | 1.05 |

As shown in Table 2, the number of disagreements drops in absolute numbers on both PD and NPD images using the modified embodiment. However, the ratio of disagreement increases. With minimal investment on the user's side, the detection can be further improved.

When the model was trained using all listed transformations, the following results set forth in Table 3 were obtained.

TABLE 3

| Transformation | Disagreement on | Disagreement on | Ratio |
|---|---|---|---|
| Function | PD (per 10,000) | NPD (per 10,000) | (NPD/PD) |
| Vertical flip | 2077 | 3440 | 1.66 |
| Horizontal flip | 1869 | 3232 | 1.73 |
| Rotate 90 deg | 2233 | 3894 | 1.74 |
| Rotate 180 deg | 2086 | 3555 | 1.70 |
| Rotate 270 deg | 2180 | 3869 | 1.77 |

As shown in Table 3, there is a reduction in the disagreement ratio, but it still remains at a significant level. This ratio may be improved, for example, by increasing the number of transformations and associated model decisions. Increasing the number of transformations may also increase the ability of the system to detect anomalies at a faster rate. The optimal number of transformations and model decisions may be determined, for example, for each use case. The number of transformations may be balanced against the number of queries that are to be monitored and the level at which the ratio is considered to be abnormal.

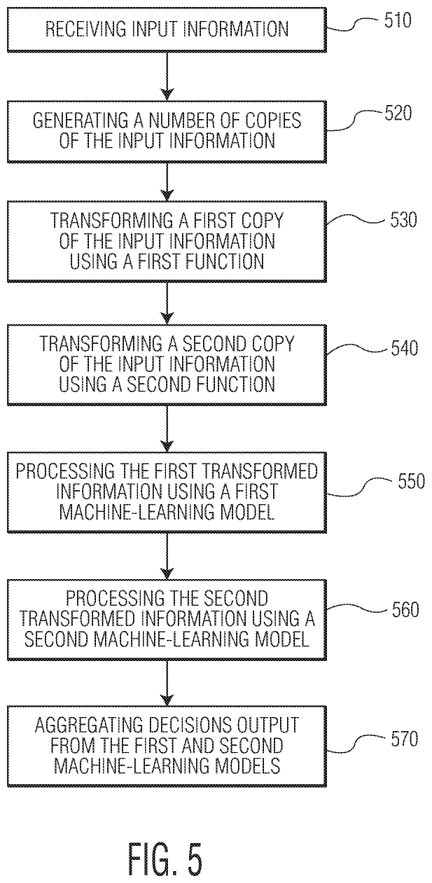

FIG. 5 illustrates an embodiment of a method for processing information using machine-learning algorithms. The method includes, at 510, receiving input information. The input information may depend, for example, on the intended application of the system. For example, when the system is used to perform image classification, the input information may be an original image. When the system is used for making financial decisions, the input information may be a specific type of account or price-related information.

At 520, the input information is copied a predetermined number of times by a copier. The copier may be any type of processor or duplicator that is able to make copies of the input information. The copying operation of 520 may be performed, for example, by copier 10 in FIG. 1. The number of copies made may correspond to the number of transformations and/or machine-learning models or may be a different number.

At 530, a first copy of the input information is transformed using a first function. In one embodiment, the transformation of the first copy may not change essential content of the input information. For example, when the input image includes a dog and the method is used to classify images into a first category of dogs and a second category of cats, the transformation performed by the first function may not change the information so much that it is no longer evident that a dog is in the transformed image.

At 540, a second copy of the input information (or the input image itself) is transformed using a second function. Like the first function, the transformation performed by the second function may not change essential content of the input information. However, the second function is different from the first function, at least in respect to one or more parameters of the image to be transformed. In one embodiment, the first function may change one parameter and the second function may perform a type of transformation that does not change any parameters relative to the input information.

At 550, the information transformed by the first function is processed by a first machine-learning model to generate a first result, e.g., classification into a first category in the example mentioned above. The first machine-learning model may be any of the types of machine-learning models discussed herein.

At 560, the information transformed by the second function is processed by the second machine-learning model to generate a second result, e.g., classification into a second category in the example mentioned above. The second machine-learning model may be based on an algorithm different from the algorithm of the first machine-learning model and may be any of the types of machine-learning models discussed herein.

At 570, the first result and the second result are aggregated to generate a decision (or outcome or answer) for the input information. The aggregation operation may be performed by the aggregator 50 in accordance with the operations described herein. In one embodiment, the decision 60 generated by the method may satisfy a certain calculated confidence level. In one embodiment, the decision may be an undefined decision. In this case, additional transformations and model outputs may be generated until a defined decision can be output from the aggregator.

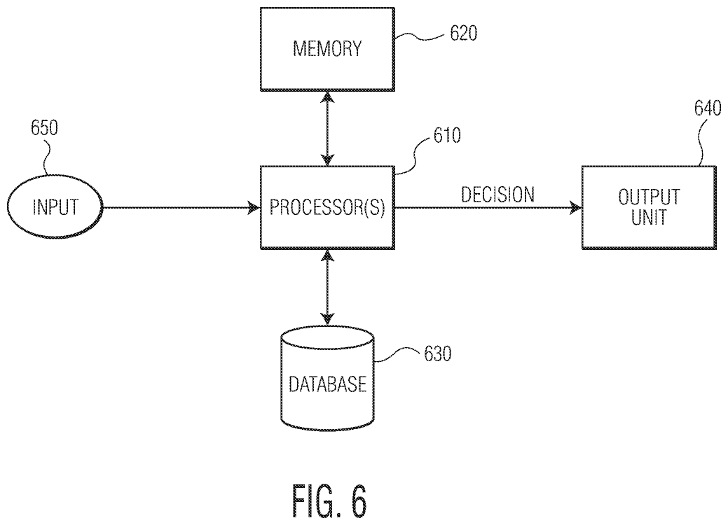

FIG. 6 illustrates a processing system which, for example, may be used to perform various operations of the embodiments described herein. The processing system includes one or more processors 610, a memory 620, and a database 630. The memory 620 stores instructions for causing the one or more processors 610 to perform the operations of the embodiments described herein. For example, the instructions stored in memory 620 may cause the processor to perform the operations of the copier, transformation modules, machine-learning models, aggregator, and controllers of the embodiments herein. The memory 620 may be a non-transitory computer-readable medium for storing the instructions. The processor(s) 610 may generate a final decision 60 for output to an output unit 640, which may be a workstation, computer terminal, mobile device, monitor, display, or another type of output unit. The processor(s) may be coupled to an input 650 for generating the decision.

### Technological Innovation

Example embodiments describe a system and method for processing information using machine-learning algorithms in a way that provides results with improved accuracy and/or detects and provides protection against malicious attack. In accordance with one embodiment, input information is copied multiple times before being processed. Each copy may be transformed with a different function which is chosen from a list of suitable functions, for example, depending on the type of input information and the original problem being considered. Each transformation function uses at least one parameter to modify a corresponding one of the copies of input information. All modified copies (and the original unmodified one) are then processed and the outputs are combined using an aggregator to produce a final result.

In one or more embodiments, the aggregator may be extended to monitor the distribution of outputs over a series of inputs. This may help to determine if an attack (e.g., cloning or adversarial examples) is being performed on the system. If so, a determination may be made as to whether to automatically limit queries or deny access to a particular user. The system may also determine whether to produce random outputs in response to queries from an attacker. This type of reaction may fool an attacker, who as a result may continue the attack without knowing that it is failing (already failed).

In these or other embodiments, the system and method may monitor the distribution of outputs over a series of inputs. This may help to determine if an attack (e.g., cloning or adversarial examples) is being performed on the machine-learning models of the system. A user of the system may decide to automatically limit queries or deny access under these circumstances. The system (e.g., the aggregator based on programming instructions stored in the computer-readable medium) may also produce random outputs in response to queries when the system is detected to be under attacker. This type of reaction may fool an attacker and he will continue the attack without knowing that it is failing (already failed).

The processors, engines, controllers, copiers, machine-learning models, neural networks, modules, transformations, units and other signal-generating and signal-processing features of the embodiments disclosed herein may be implemented in logic which, for example, may include hardware, software, or both. When implemented at least partially in hardware, the processors, engines, controllers, copiers, machine-learning models, neural networks, modules, transformations, units and other signal-generating and signal-processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the processors, engines, controllers, copiers, machine-learning models, neural networks, modules, transformations, units and other signal-generating and signal-processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Although the various exemplary embodiments have been described in detail with particular reference to certain exemplary aspects thereof, it should be understood that the invention is capable of other example embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

We claim:

1. A method for processing information, comprising:
transforming first information based on a first function;
transforming second information based on a second function;
processing the first transformed information using a first machine-learning model to generate a first result;
processing the second transformed information using a second machine-learning model to generate a second result; and
aggregating the first result and the second result to generate a decision.

2. The method of claim 1, wherein:
the first function is different from the second function,
the first machine-learning model is based on a first algorithm, and
the second machine-learning algorithm is based on a second algorithm different from the first algorithm.

3. The method of claim 2, wherein:
the first function changes a first parameter of the first information, and
the second function changes a second parameter of the second information which is different from the first parameter.

4. The method of claim 1, wherein said aggregating includes applying a voting algorithm to the first result and the second result to generate the decision.

5. The method of claim 1, wherein said aggregating includes applying a statistical algorithm to the first result and the second result to generate the decision.

6. The method of claim 1, wherein the decision classifies input information corresponding to the first information and the second information.

7. The method of claim 1, wherein the decision is an undefined decision.

8. The method of claim 7, further comprising:
a) performing one or more additional transformations,
b) processing information from the one or more additional transformations using a third machine-learning model to generate a third result, and
c) aggregating the first result, the second result, and the third result to generate another decision different from the undefined decision, wherein the information processed in c) is equal to the first information and the second information.

9. The method of claim 8, wherein the third machine-learning model corresponds to:
the first machine-learning model with at least one parameter changed,
the second machine-learning model with at least one parameter changed, or
a machine-learning model different from the first machine-learning model and the second machine-learning model.

10. A system for processing information, comprising:
a first module configured to transform first information based on a first function;
a second module configured to transform second information based on a second function;
a processing system configured to process the first transformed information using a first machine-learning model to generate a first result and to process the second transformed information using a second machine-learning model to generate a second result; and
an aggregator configured to generate a decision based on the first result and the second result, wherein the first information is equal to the second information.

11. The system of claim 10, wherein:
the first function is different from the second function,
the first machine-learning model is based on a first algorithm, and
the second machine-learning algorithm is based on a second algorithm different from the first algorithm.

12. The system of claim 11, wherein:
the first function changes a first parameter of the first information, and
the second function changes a second parameter of the second information which is different from the first parameter.

13. The system of claim 10, wherein the aggregator is configured to generate the decision using a voting algorithm or a statistical algorithm.

14. The system of claim 10, wherein the decision classifies input information corresponding to the first information and the second information.

15. The system of claim 10, wherein the decision is an undefined decision.

16. The system of claim 10, wherein the processing system includes:
a first processor configured to process the first transformed information using the first machine-learning model to generate the first result, and
a second processor configured to process the second transformed information using the second machine-learning model to generate the second result.

17. A non-transitory computer-readable medium storing instructions for causing at least one processor to perform operations including:
transforming first information based on a first function;
transforming second information based on a second function;
processing the first transformed information using a first machine-learning model to generate a first result;
processing the second transformed information using a second machine-learning model to generate a second result; and
aggregating the first result and the second result to generate a decision, wherein the first information is equal to the second information.

18. The medium of claim 17, wherein:
the first function is different from the second function,
the first machine-learning model is based on a first algorithm, and
the second machine-learning algorithm is based on a second algorithm different from the first algorithm.

19. The medium of claim 18, wherein:
the first function changes a first parameter of the first information, and
the second function changes a second parameter of the second information which is different from the first parameter.
